(19) United States
(12) Patent Application Publication
(10) Pub. No.: US 2011/0222023 A1
(43) Pub. Date: Sep. 15, 2011

(54) ILLUMINATION DEVICE AND PROJECTION DISPLAY DEVICE

(75) Inventor: Michihiro OKUDA, Hirakata-City (JP)

(73) Assignee: SANYO ELECTRIC CO., LTD., Moriguchi-shi (JP)

(21) Appl. No.: 13/114,108

(22) Filed: May 24, 2011

Related U.S. Application Data
(63) Continuation of application No. PCT/JP2009/069795, filed on Nov. 24, 2009.

(30) Foreign Application Priority Data
Dec. 5, 2008 (JP) 2008-311617

(51) Int. Cl. G03B 21/14; F21V 8/00

(52) U.S. Cl. 353/30; 362/235; 362/551; 362/558

(57) ABSTRACT

An illumination device includes: a modulating portion which modulates light; a plurality of light source portions which is disposed in correspondence with a plurality of divided sections formed by dividing a light modulation area of the modulating portion; a light-guiding optical system which guides light from the plurality of light source portions to the plurality of corresponding divided sections; a power output adjustment portion which adjusts power outputs of the light source portions corresponding to the divided sections in accordance with image signals applied to the divided sections; and a modulation control portion which controls the modulating portion in accordance with power outputs of the light source portions and the image signals.

This application is a Continuation of PCT/JP2009/069795 filed 24 Nov. 2009 and claims priority under 35 U.S.C. Section 119 of Japanese Patent Application No. 2008-311617 filed Dec. 5, 2008, entitled “ILLUMINATION DEVICE AND PROJECTION DISPLAY DEVICE”. The disclosure of the above application is incorporated herein by reference.

### BACKGROUND OF THE INVENTION

1. Field of the Invention

The present invention relates to an illumination device and a projection display device that modulate light from a light source in accordance with an image signal and output the modulated light. More specifically, the present invention is suitable for use in an illumination device and a projection display device that provide light with higher brightness using a plurality of light sources.

2. Disclosure of Related Art

Conventionally, there are known projection display devices (hereinafter, referred to as “projectors”) that modulate light from light sources in accordance with image signals and project light generated by the modulation (hereinafter, referred to as “image light”) onto a projection plane. For this type of projectors, there has been growing demand for higher-brightness image light with increase of screen size in recent years. Accordingly, there is the need to provide illumination light with higher brightness.

To satisfy the need, a large number of light sources can be arranged in a one-dimensional or two-dimensional array, thereby achieving optical integration. In addition, in another arrangement for achieving higher-brightness illumination light, for example, light from a plurality of light sources is coupled to a plurality of optical fibers, and these optical fibers are bundled together so as to combine the light emitted from the optical fibers.

However, using such a large number of light sources inevitably raises power consumption of the device. In addition, if the light sources are continuously driven by large current, the light sources are shortened in lifetime.

Accordingly, such a projector may be configured to reduce all or some of the light sources in power in a power saving mode (long-life mode). This allows long lifetime of the light sources and low power consumption of the device.

In the thus configured projector, however, lowering power of the light sources leads to decrease in lightness of an entire projection image. This may result in deterioration of image quality in exchange for low power consumption of the device and long lifetime of the light sources.

### SUMMARY OF THE INVENTION

An illumination device in a first aspect of the present invention includes: a modulating portion which modulates light; a plurality of light source portions which is disposed in correspondence with a plurality of divided sections formed by dividing a light modulation area of the modulating portion; a light-guiding optical system which guides light from the plurality of light source portions to the plurality of corresponding divided sections; a power output adjustment portion which adjusts power outputs of the light source portions corresponding to the divided sections in accordance with image signals applied to the divided sections; and a modulation control portion which controls the modulating portion in accordance with power outputs of the light source portions and the image signals.

A projection display device in a second aspect of the present invention includes an illumination device and a projection optical system which enlarges and projects image light from the illumination device. In this aspect, the illumination device includes a modulating portion which modulates light; a plurality of light source portions which is disposed in correspondence with a plurality of divided sections formed by dividing a light modulation area of the modulating portion; a light-guiding optical system which guides light from the plurality of light source portions to the plurality of corresponding divided sections; a power output adjustment portion which adjusts power outputs of the light source portions corresponding to the divided sections in accordance with image signals applied to the divided sections; and a modulation control portion which controls the modulating portion in accordance with power outputs of the light source portions and the image signals.

### BRIEF DESCRIPTION OF THE DRAWINGS

The foregoing and other objects and novel features of the present invention will be more fully understood from the following description of a preferred embodiment when reference is made to the accompanying drawings.

FIG. 1 is a diagram showing a configuration of an optical system of a projector in an embodiment of the present invention;

FIGS. 2A to 2C are diagrams showing a configuration of an illumination device and an integrator in the embodiment;

FIGS. 3A to 3D are diagrams for describing a fixed structure of integrator rods in the integrator in the embodiment;

FIGS. 4A and 4B are diagrams showing a state of irradiation of imagers with laser light emitted from the integrator in the embodiment;

FIG. 5 is a diagram showing a configuration of a control system for driving and controlling the imagers and laser light sources in the projector in the embodiment;

FIGS. 6A and 6B are diagrams showing relationships between a projection image on the screen and power outputs of the light source portions in the embodiment;

FIG. 7 is a schematic view of an optical system ranging from an illumination device to imagers in a modification example;

FIG. 8 is a diagram showing a configuration of an optical system of a projector in the modification example;

FIG. 9 is a diagram showing a configuration of an optical system of a projector in another modification example;

FIGS. 10A to 10C are diagrams for describing a configuration of a light source device, a fly-eye lens, and a condenser array in another modification example; and

FIG. 11 is a diagram for describing another configuration of the optical system of the projector in another modification example.

However, the drawings are intended only for illustration and do not limit the scope of the present invention.

### DESCRIPTION OF PREFERRED EMBODIMENTS

A projector in an embodiment of the present invention will be described below with reference to the drawings.

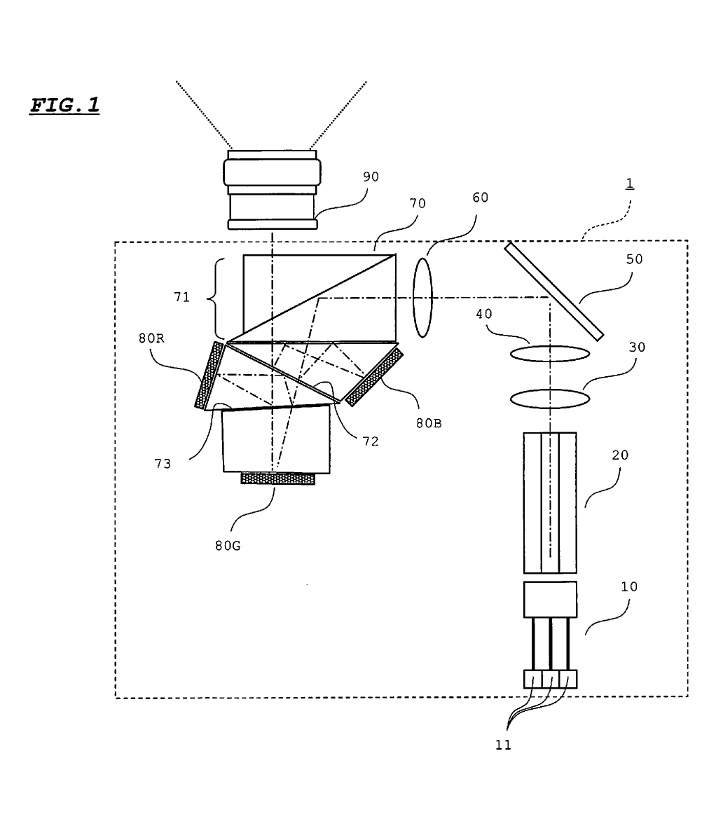

FIG. 1 is a diagram showing a configuration of an optical system of the projector. The arrangement except for a projection lens 90 in FIG. 1 constitutes an optical system of an illumination device 1 installed in the projector in this embodiment. In FIG. 1, an R light imager 80R, a G light imager 80G, and a B light imager 80B are equivalent to a modulating portion in the present invention; light source portions 11 constituting a light source device 10 are equivalent to light source portions in the present invention; and a component portion intervened between the light source device 10 and the R light imager 80R, G light imager 80G, and B light imager 80B, is equivalent to a light-guiding optical system in the present invention.

The light source device 10 emits white illumination light in which laser light of a red wavelength band (hereinafter, referred to as “R light”), laser light of a green wavelength band (hereinafter, referred to as “G light”), and laser light of a blue wavelength band (hereinafter, referred to as “B light”) are combined together. The light source device 10 is configured to integrate R light, G light, and B light emitted from a plurality of laser light sources using optical fibers. A detailed configuration of the light source device 10 will be described later.

The illumination light emitted from the light source device 10 is unified in illuminance distribution by an integrator 20, and entered into a Total Internal Reflection (TIR) prism 71 of a 3-Digital Micro-mirror Device (DMD) color separation/combination prism 70 via relay lenses 30 and 40, a mirror 50, and a relay lens 60. A detailed configuration of the 3-DMD color separation/combination prism 70 is described in JP-A No. 2006-79080, for example.

The illumination light entered into the 3-DMD color separation/combination prism 79 is separated by dichroic films 72 and 73 constituting the 3-DMD color separation/combination prism 70, and then entered into respective modulation areas of the reflective R light imager 80R, G light imager 60G, and B light imager 80B formed by DMDs. The R light, G light, and B light modulated by these imagers 80R, 80G, and 80B are integrated in light path by the 3-DMD color separation/combination prism 70, and the combined color light (image light) is entered from the TIR prism 71 into a projection lens 90 (equivalent to a projection optical system of the present invention).

The image light entered into the projection lens 90 is enlarged and projected onto a screen (projection plane). Accordingly, a predetermined image is displayed on the screen in accordance with the image signal.

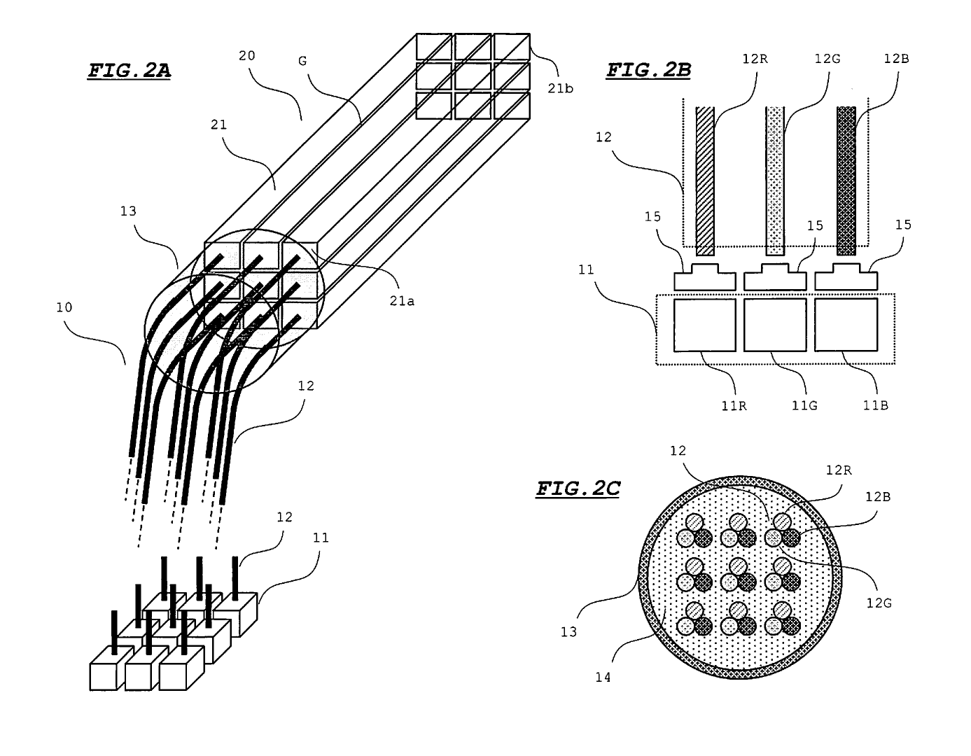

FIGS. 2A to 2C are diagrams showing a configuration of the light source device 10 and the integrator 20. FIG. 2A is a perpendicular view of the light source device 10 and the integrator 20. FIG. 2B is a diagram showing a configuration of light source portions 11 and a neighborhood thereof in the light source device 10. FIG. 2C is a diagram (front view) showing a bundle structure of a plurality of optical fiber groups 12 with a bundle 13 in the light source device 10.

The light source device 10 includes nine light source portions 11, nine optical fiber groups 12 arranged in correspondence with these light source portions 11, and a bundle 13 bundling together these optical fiber groups 12, as shown in FIG. 2A.

The light source portions 11 are each formed by a red laser light source 11R emitting R light, a green laser light source 11G emitting G light, and a blue laser light source 11B emitting B light, as shown in FIG. 2B. In addition, the optical fiber groups 12 are each formed by an R light optical fiber 12R, a G light optical fiber 12G, and a B light optical fiber 12B. These three optical fibers 12R, 12G, and 12B are bonded and integrated together with an adhesive agent. Alternatively, the three optical fibers 12R, 12G, and 12B may be integrated by bundling together with a band, inserting into a tube, or the like.

The R light, G light, and B light emitted from the laser light sources 11R, 11G, and 11B are respectively entered via fiber couplers 15 into the optical fibers 12R, 12G, and 12B, and propagated through the fibers, and emitted from leading end portions of the fibers.

The nine optical fiber groups 12 are bundled together at leading end portions with the bundle 13. The optical fiber groups 12 are each disposed in the bundle 13 in three rows by three columns with a predetermined pitch, as shown in FIG. 2C. The bundle 13 is filled with a filling material 14 such as epoxy resin, whereby the optical fiber groups 12 are fixed within the bundle 13.

The integrator 20 is formed by nine integrator rods 21 as shown in FIG. 2A. The nine integrator rods 21 are bundled together in three rows and three columns, and are integrated together through adhesions between boundary surfaces.

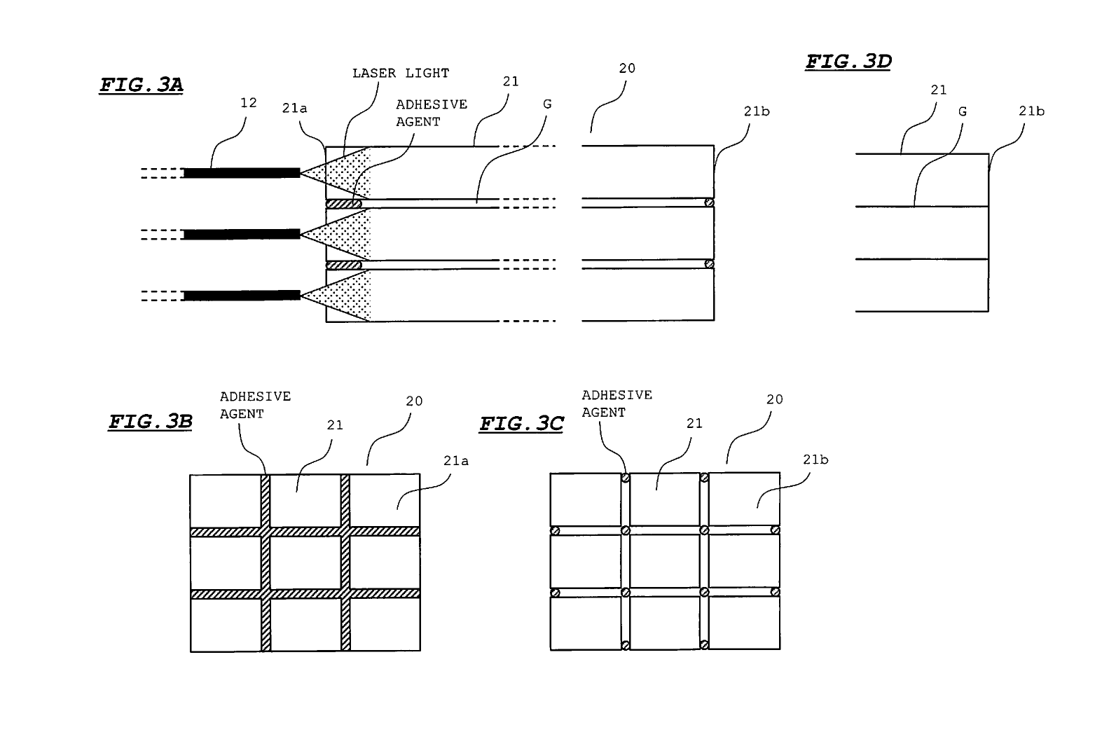

FIGS. 3A to 3D are diagrams for describing a fixed structure of the integrator rods 21. FIGS. 3A to 3C are diagrams of the integrator 20 as seen from a lateral side, an incidence plane, and an output plane, respectively. FIG. 3D is a diagram showing a configuration example of the integrator rods 21 not adhered together at output end portions.

As shown in FIGS. 3A to 3C, the integrator rods 21 are each bonded with an adhesive agent on incidence end sides and output end sides. In this arrangement, if an adhesive agent is applied to the boundary surfaces (side surfaces) of the rods, the rods are lowered in laser light reflectance at the adhesive-applied portions. Accordingly, in the incidence sides of the integrator rods 21, an adhesive agent is applied to only the boundary surfaces close to the incidence end planes 21a to which incident laser light is not radiated, as shown in FIGS. 3A and 3B. In addition, in the output end sides of the integrator rods 21, an adhesive agent is also applied to the boundary surfaces in a dotted pattern, thereby to reduce the adhesive agent-applied area as much as possible, as shown in FIG. 3C. The applied adhesive agent has a thickness of about several to 10 μm, for example, and the adjacent integrator rods 21 each have an air gap G formed therebetween due to the thickness of the adhesive agent.

If the integrator rods 21 can be sufficiently bonded and fixed with an adhesive agent only on the incidence end sides, the rods may not necessarily be bonded with an adhesive agent on the output end sides but may be merely bundled together on the output end sides as shown in FIG. 3D. In this case, the integrator rods 21 are not lowered in light reflectance due to an adhesive agent on the output end sides.

Returning to FIG. 2A, a pitch of the optical fiber groups 12 is made almost identical to the pitch of the integrator rods 21. In addition, the light source device 10 and the integrator 20 are disposed such that leading end surfaces of the optical fiber groups 12 are opposed to the incidence planes 21a of the integrator rods 21.

Accordingly, the three color RGB lights emitted from the optical fiber groups 12 are entered into the corresponding integrator rods 21. As described above, the air gaps G are formed between adjacent integrator rods 21. Therefore, the laser light incident on each of the integrator rods 21 is propagated through the rod while being totally reflected due to a difference in refraction index between the rod and the air, unified in illuminance distribution, and then emitted from the output planes 21b.

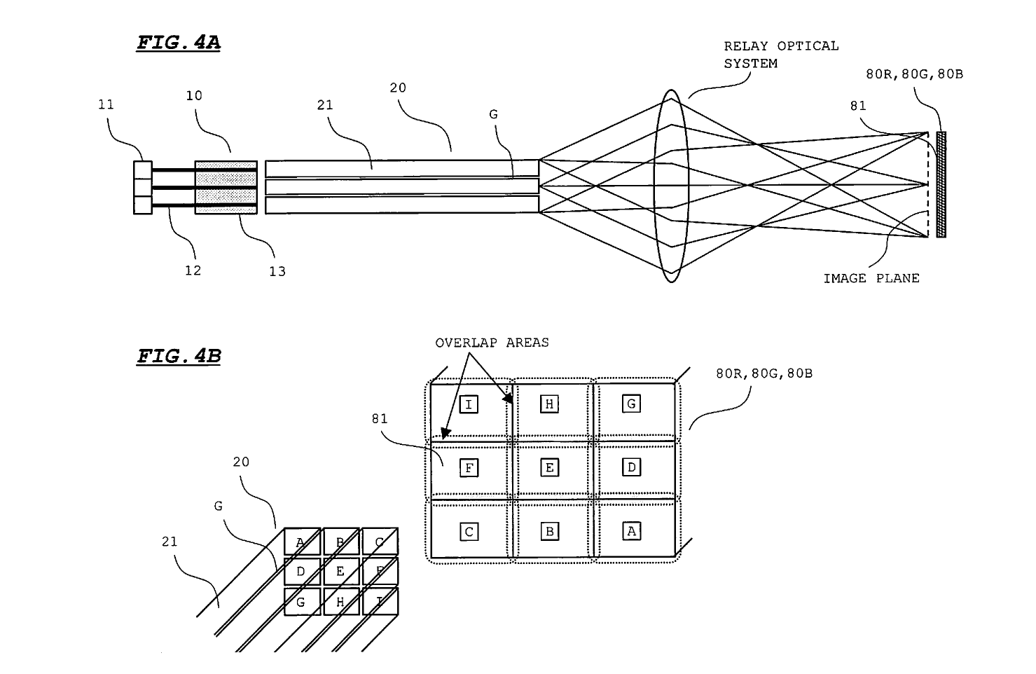

FIGS. 4A and 4B are diagrams showing a state of irradiation of the imagers 80R, 80G, and 80B with laser light emitted from the integrator 20.

FIG. 4A is a schematic view of the optical system ranging from the light source device 10 to the imagers 80R, 80G, and 80B. FIG. 4B is a diagram showing schematically sections on modulation areas 81 of the imagers 80R, 80G, and 80B to which the laser light emitted from the integrator rods 21 are applied. FIG. 4A depicts a relay optical system including the relay lenses 30, 40, and 60, the mirror 50, and the 3-DMD color separation/combination prism 70, by a single lens for the sake of convenience. In FIG. 4B, the integrator rods 21 are given reference codes A to I, and similarly, the divided sections to which the laser light from the integrator rods 21 are applied are also given reference codes A to I, for the sake of convenience.

The laser light emitted from the integrator 20 is separated in the relay optical system into R light, G light, and B light as described above with reference to FIG. 1. The separated R light, G light, and B light are radiated to the entire modulation areas 81 of the corresponding imagers 80R, 80G, and 80B. At that time, the laser light (R light, G light, and B light) emitted from the integrator rods 21 is radiated to the sections on the modulation area 81 corresponding to the integrator rods 21. That is, each of the modulation areas 81 is divided into nine sections, which are the same as the number of the integrator rods 21. Accordingly, laser light from one light source portion 11 is radiated into one divided section.

Laser light is radiated in vertically and horizontally reversed positions with respect to the modulation area 81 by the lens function of the relay optical system as shown in FIG. 4B. For example, laser light from the integrator rod 21 with reference code A located in an upper left position is radiated into the lower right position, that is, into the divided section with reference code A, in the modulation area 81. In addition, laser light from the other integrator rods 21 with reference codes B to I is also radiated to the divided sections with the same reference codes as shown in FIG. 4B.

In this arrangement, the positions of the reflection planes of the imagers 80R, 80G, and 80B are slightly displaced backward from an image plane formed by the relay optical system, as shown in FIG. 4A. As a result, the laser light radiated to the modulation areas 81 is slightly larger in size than the image plane. This causes laser light radiated to adjacent divided sections to overlap slightly at boundaries between the sections as shown in FIG. 4B (hereinafter, such areas where laser light overlaps will be referred to as “overlap areas”). Accordingly, even if the air gaps G are produced between the rod integrators 20, boundary lines due to these gaps do not appear on a projection image.

If the reflection planes of the imagers 80R, 80G, and 80B are displaced from the image plane, the image is blurred by the displacement. Accordingly, an amount of displacement between the reflection planes and the image plane is adjusted such that the image blurriness does not become a problem from a practical standpoint and the boundary lines do not become prominent.

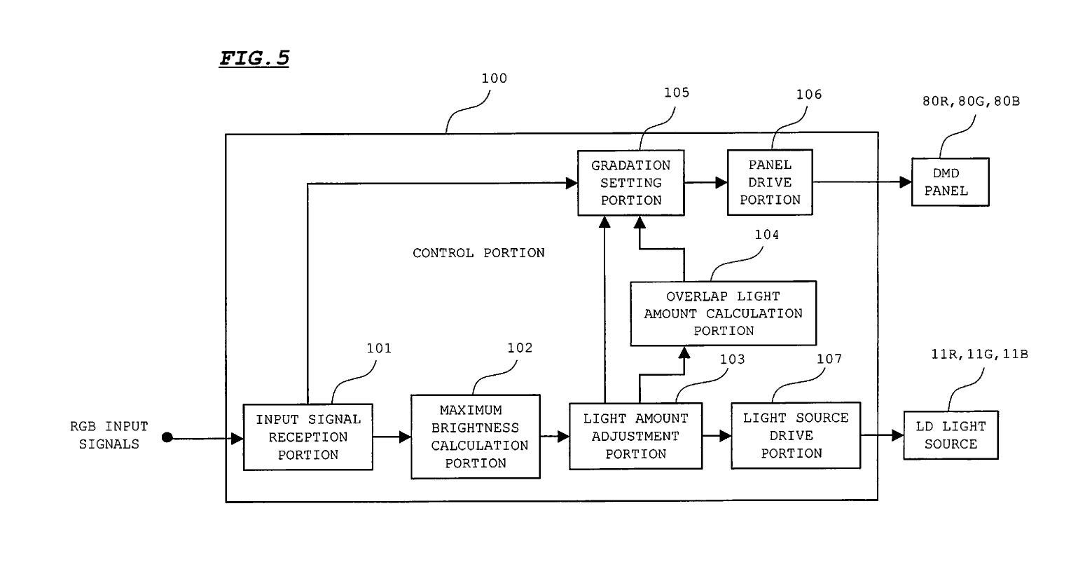

FIG. 5 is a diagram showing a configuration of a control system for driving and controlling the imagers 80R, 80G, and 80B, and the laser light sources 11R, 11G, and 11B. In FIG. 5, the control portion 100 is included in a circuit system of the illumination device 1 installed in the projector.

The imagers 80R, 80G, and 80B, and the laser light sources 11R, 11G, and 11B are driven and controlled by the control portion 100. The control portion 100 determines brightnesses necessary for the divided sections of the imagers 80R, 80G, and 80B from input image signals, and decides amounts of light radiated to the divided sections so as to obtain the necessary brightnesses. Then, based on the decided light amounts, the control portion 100 controls power outputs of the light source portions 11 corresponding to the divided sections, that is, power outputs of the laser light sources 11R, 11G, and 11B. Further, the control portion 100 sets gradations of pixels within the divided sections in accordance with the amounts of light radiated to the divided sections, that is, the power outputs of the light source portions 11, thereby controlling the imagers 80R, 80G, and 80B.

To exercise such control, the control portion 100 includes an input signal reception portion 101, a maximum brightness calculation portion 102, a light amount adjustment portion 103 (equivalent to a power output adjustment portion in the present invention), an overlap light amount calculation portion 104, a gradation setting portion 105 (equivalent to a modulation control portion in the present invention), a panel drive portion 106, and a light source drive portion 107.

The input signal reception portion 101, upon reception of image signals (for example, RGB input signals) for one frame (one image screen), outputs these image signals to the maximum brightness calculation portion 102 and the gradation setting portion 105.

The maximum brightness calculation portion 102 calculates respective maximum brightnesses necessary for the divided sections of the imagers 80R, 80G, and 80B in accordance with the input image signals. For example, the maximum brightness calculation portion 102 compares sequentially brightnesses necessary for the individual pixels in the divided sections, and sets the largest brightness as maximum brightness. The brighter (closer to white) an image created by modulation in the divided sections becomes, the higher the maximum brightness becomes. The maximum brightness calculation portion 102 outputs the calculated maximum brightnesses for the divided sections to the light amount adjustment portion 103.

The light amount adjustment portion 103 decides amounts of light necessary for the divided sections, that is, amounts of R light for the divided sections in the imager 80R, amounts of G light for the divided sections in the imager 80G, and amounts of B light for the divided section in the imager 80B, on the basis of the input maximum brightnesses. Then, the light amount adjustment portion 103 decides power output values of the laser light sources 11R, 11G, and 11B of the nine light source portions 11 so as to obtain the decided light amounts. At that time, the power output values of the laser light sources 11R, 11G, and 11B are set larger corresponding to the divided sections with higher maximum brightnesses, and the power output values of the light sources 11R, 11G, and 11B are set smaller corresponding to the divided sections with lower maximum brightnesses.

The light amount adjustment portion 103 outputs the thus decided power output values to the light source drive portion 107. In addition, the light amount adjustment portion 103 outputs information on the decided light amounts for the divided sections (amounts of R light, B light, and G light) (hereinafter, referred to as “main light amount information”) to the overlap light amount calculation portion 104 and the gradation setting portion 105.

The overlap light amount calculation portion 104 calculates amounts of light radiated to the above-mentioned overlap areas (refer to FIG. 4B) for the imagers 80R, 80G, and 80B, on the basis of the input main light amount information. Then, the overlap light amount calculation portion 104 outputs information on the calculated light amounts (hereinafter, referred to as “overlap light amount information) to the gradation setting portion 105.

The gradation setting portion 105 sets gradations of individual pixels within the divided sections of the imagers 80R, 80G, and 80B, on the basis of the image signals from the input signal reception portion 101 and the main light amount information, and also sets gradations of individual pixels within the overlap areas on the basis of the image signals and the overlap light amount information.

Specifically, taking the imager 80R as an example, if an amount of R light radiated to the relevant divided sections (hereinafter, referred to as “current light amount”) is smaller than an amount of R light with maximum power output of the laser light source 11R (hereinafter, referred to as “maximum light amount”) because the power output of the laser light source 11R is adjusted in correspondence with the divided sections, the gradation setting portion 105 raises the gradations of the individual pixels so as to obtain the brightness with the maximum light amount, in accordance with the ratio of the current light amount to the maximum light amount. In addition, the gradation setting portion 105 adjusts the gradations of the individual pixels in the overlap areas so as to obtain the brightness with the maxim light amount, in accordance with the ratio of a light amount for the overlap areas to the maximum light amount. At that time, if the light amount for the overlap areas is larger than the maximum light amount, the gradation setting portion 105 reduces the gradations of the individual pixels in the overlap areas. If the light amount for the overlap areas is lower than the maximum light amount, the gradient setting portion 105 raises the gradients of the individual pixels in the overlap areas. As for the other imagers 80G and 80B, the gradation setting portion 105 also adjusts the gradations of the individual pixels so as to obtain the brightness with the maximum light amount, as in the case of the imager 80R.

The gradation setting portion 105 outputs a panel control signal for activating the imagers 80R, 80G, and 80B to the panel drive portion 106 such that the individual pixels have the set gradations. The panel drive portion 106 outputs a drive signal to the imagers 80R, 80G, and 80B, in accordance with the panel control signal from the panel drive portion 106.

At that time, in synchronization with the output of the panel control signal, the light amount adjustment portion 103 outputs a laser control signal for activating the laser light sources 11R, 11G, and 11B to the light source drive portion 107 such that the light sources have the decided power output values. The light source drive portion 107 outputs a drive signal to the laser light sources 11R, 11G, and 11B, in accordance with the laser control signal from the light amount adjustment portion 103.

Accordingly, the necessary amounts of laser light (R light, G light, and B light) are radiated to the corresponding divided sections of the imagers 80R, 80G, and 80B from the respective laser light sources 11R, 11G, and 11B of the nine light source portions 11. The R light, G light, and B light radiated to the imagers 80R, 80G, and 80B are modulated by the imagers 80R, 80G, and 80B and combined by the 3-DMD color separation/combination prism 70 into image light, and then the image light is projected onto a screen via the projection lens 90, as described above with reference to FIG. 1.

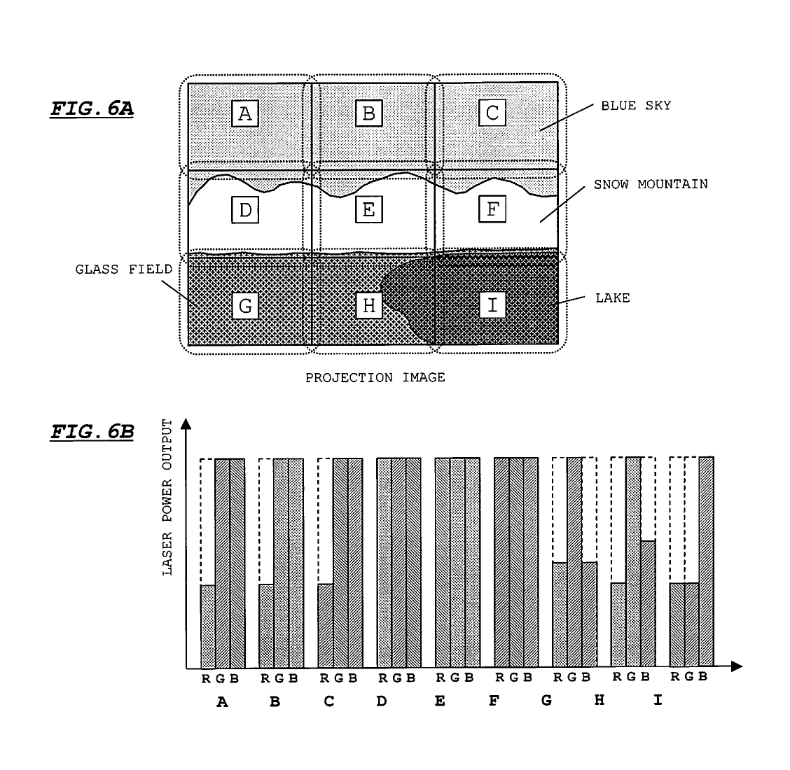

FIGS. 6A and 6B are diagrams showing relationships between a projection image on the screen and the power outputs of the light source portions 11. FIG. 6A is a diagram showing one example of a projection image. FIG. 6B is a diagram showing power outputs of the light source portions 11 with the projection image of FIG. 6A displayed on the screen. Sections A to I shown in FIG. 6A correspond to the divided sections A to I of the imagers 80R, 80G, and 80B shown in FIG. 4B. In addition, the power outputs of the light source portions 11 shown in FIG. 6B are represented by power outputs of the laser light sources 11R, 11G, and 11B.

With reference to FIG. 6A, a scenery image with a glass field, a lake, and a snow mountain on the back of the glass field and the lake, is projected on the screen. In this projection image, necessary amounts of R light, G light, and B light vary among sections with the snow mountain (D, E, and F), sections with a blue sky (A, B, and C), a section with the glass field (G), a section with the glass field and the lake (H), and a section with the lake (I).

In this arrangement, the power outputs of the light source portions 11, that is, the power outputs of the laser light sources 11R, 11G, and 11B are adjusted in accordance with image signals for generating the image of the sections A to I. Accordingly, the power outputs of the laser light sources 11R, 11B, and 11B are set in accordance with brightnesses of respective color representations as shown in FIG. 6B.

Therefore, the power consumption of the light source device can be made lower as compared with the case where all the light source portions 11 (laser light sources) are unified in power output as shown by dashed lines in FIG. 6B.

According to this embodiment as described above, the power outputs of the corresponding light source portions 11 are individually adjusted in accordance with the image signals applied to the divided sections of the imagers 80R, 80G, and 80B, which achieves reduction of power consumption at the plurality of light source portions as a whole. In addition, if the light amounts for the divided sections are smaller than the maximum light amounts, the gradations of the individual pixels within the divided sections are raised in accordance with the adjusted power outputs of the light source portions 11 and the image signals, whereby a projection image can be provided with a brightness identical to that with the maximum light amounts for the divided sections.

Therefore, it is possible to prevent reduction in brightness of an entire projection image by adjusting the power outputs of the light source portions 11, thereby suppressing deterioration of image quality.

In addition, according to this embodiment, since the modulation areas 81 of the imagers 80R, 80G, and 80B are displaced from the image plane by the relay optical system, laser light overlaps slightly at boundaries between adjacent divided sections. This makes the boundary lines of the divided sections unlikely to appear on a projection image.

Further, according to this embodiment, since the gradations of an image in overlap areas are set in accordance with an amount of light radiated to the overlap areas, it is possible to suppress variations in lightness of a projection image under the influence of the overlap areas, thereby to prevent deterioration of image quality.

Moreover, according to this embodiment, a plurality of integrator rods 21 is arranged in correspondence with a plurality of divided sections, whereby light from the light source portions 11 can be effectively guided to the corresponding divided sections.

### Modification Example of the Optical System

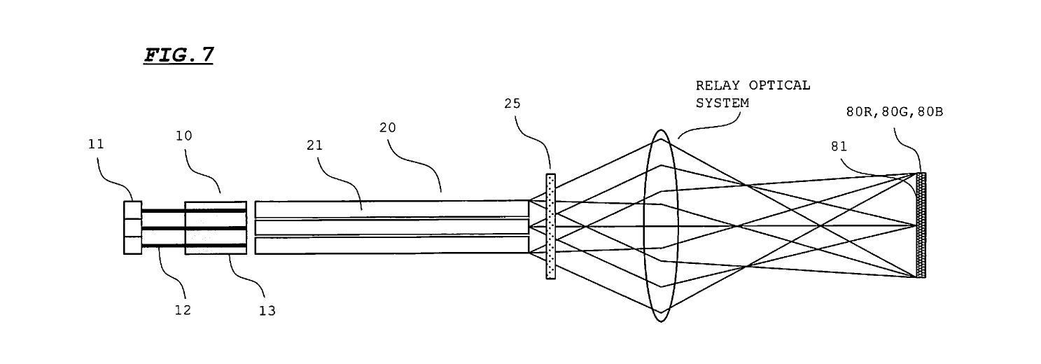

FIG. 7 is a schematic view of the optical system ranging from the light source device 10 to the imagers 80R, 80G, and 80B in a modification example.

In this modification example, a diffuser 25 is arranged in the vicinity of the output end portion of the integrator 20, instead of displacing the modulation areas 81 of the imagers 80R, 80G, and 80B from the image plane by the relay optical system. With such disposition of the diffuser 25, laser light does not form a proper image on the imagers 80R, 80G, and 80B, but overlaps slightly at boundaries between adjacent divided sections as in the case of the foregoing embodiment.

Therefore, the configuration of this modification example also makes the boundary lines between the divided images less prone to appear in a projection image as in the case of the foregoing embodiment.

If the diffuser 25 does not perform proper image formation, the projection image is blurred accordingly. Therefore, it is desired that the diffuser 25 has the degree of diffusion with which image blurriness does not become a problem from a practical standpoint. In addition, the diffuser 25 may be arranged in any position of the relay optical system. However, for minimum degree of diffusion, the diffuser 25 is desirably arranged in the vicinity of the integrator 20 or in the vicinity of the imagers 80R, 80G, and 80B, as shown in FIG. 7.

Although embodiments of the present invention are as described above, the present invention is not limited to these embodiments.

For example, although in the foregoing embodiment, the illumination optical system is used with the 3-DMD color separation/combination prism 70, any other illumination optical system may be used instead. In a possible example of an illumination optical system, color lights separated by a plurality of dichroic mirrors are entered into three liquid crystal panels from three directions, and then are modulated by the liquid crystal panels and combined by a dichroic cube.

In addition, each of the light source portions 11 is formed by the laser light sources 11R, 11G, and 11B, one each light source for each color. Alternatively, each of the light source portions 11 may be formed by pluralities of laser light sources 11R, 11G, and 11B. In this case, the proportions of the laser light sources 11R, 11G, and 11B can be decided under appropriate condition(s). For example, if white light with a color temperature 6500° C. (D65) is to be created using the red laser light sources 11R with a wavelength of 642 nm and a power of 7 W, the green laser light sources 11G with a wavelength of 532 nm and a power of 5.1 W, and the blue laser light source 11B with a wavelength of 465 nm and a power of 5.1 W, the proportions of the light sources may be red laser light sources: green laser light sources: blue laser light sources ≈3:2:2.

In addition, in the foregoing embodiment, the integrator rods 21 are arranged in three rows and three columns, which causes the modulation areas 81 of the imagers 80R, 80G, and 80B to be divided in a three-row and three-column pattern. However, the arrangement of the integrator rods 21, that is, the division of the modulation areas 81 is not limited to the foregoing three-row and three-column pattern, and any other appropriate arrangement (division) pattern may be used. For example, arrangement (division) may be carried out in two rows and two columns, four rows and four columns, eight rows and eight columns, three rows and four columns, and others.

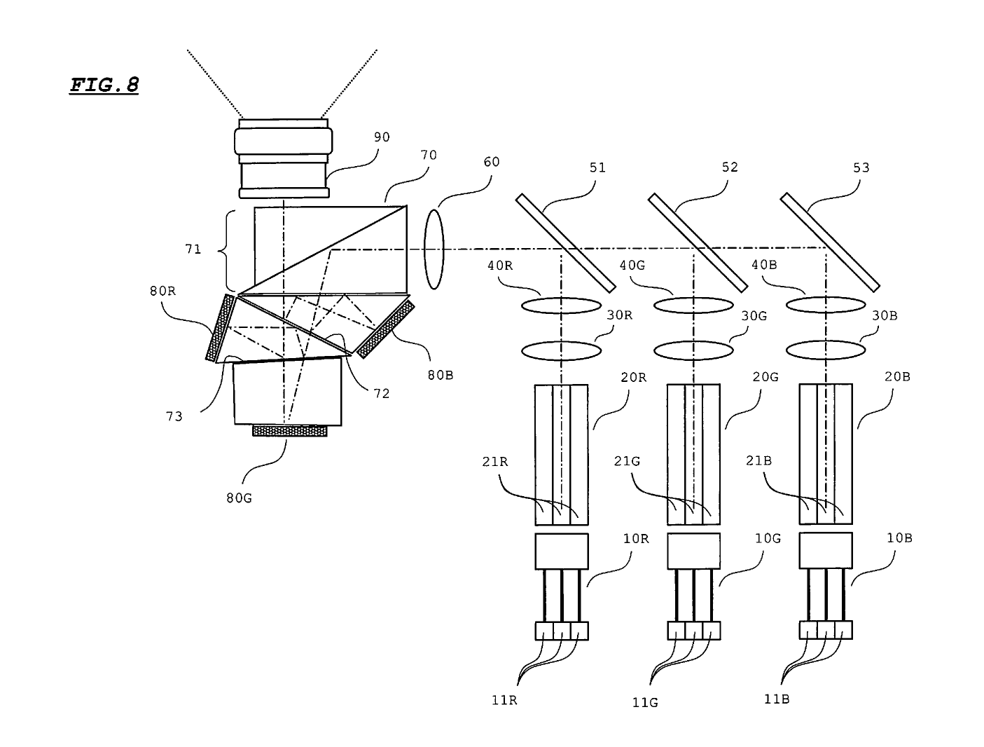

Further, in the foregoing embodiment, one light source device 10 emits three RGB laser lights. However, the optical system of the illumination device 1 is not limited to this arrangement, but may have light source devices for respective colors, as shown in FIG. 8, for example.

Specifically, the configuration of FIG. 8 has three light source devices: a light source device 10R including solely the red laser light source portions 11R; a light source device 10G including solely the green laser light source portions 11G; and a light source device 10B including solely the blue laser light source portions 11B. The red laser light source portions 11R, the green laser light source portions 11G, and the blue laser light source portions 11B have pluralities of red laser light sources, green laser light sources, and blue laser light sources, respectively, and fiber couplers for entering laser light from these laser light sources to corresponding optical fibers.

In FIG. 8, reference numerals 20R, 20G, and 20B denote integrators for the light source device 10R, the light source device 10G, and the light source device 10B. In addition, reference numerals 30R and 40R denote relay lenses for the light source device 10R; 30G and 40G denote relay lenses for the light source device 10G; and 30B and 40B denote relay lenses for the light source device 10B.

Dichroic mirrors 51 and 52 and a mirror 53 are disposed at stages subsequent from the relay lenses 40R, 40G, and 40B for RGB lights, respectively. That is, the R light emitted from the integrator 20R is reflected by the dichroic mirror 51. The G light emitted from the integrator 20G is reflected by the dichroic mirror 52 and then passes through the dichroic mirror 51. The B light emitted from the integrator 20B is reflected by the mirror 53 and then passes through the dichroic mirrors 52 and 51. Accordingly, the laser light from the three light source devices 10R, 10G, and 10B is combined and entered into the 3-DMD color separation/combination prism 70.

In the configuration of FIG. 8, the numbers of the integrator rods 21R, 21G, and 21B constituting the integrators 20R, 20G, and 20B can be made identical. In this case, the numbers of divided sections are made identical at all the imagers 80R, 80G, and 80B. Alternatively, the numbers of the integrator rods 21R, 21G, and 21B for the light source devices 10R, 10G, and 10B may be different. In this case, the numbers of the divided sections are different among the imagers 80R, 80G, and 80B.

In addition, in the configuration of FIG. 8, the numbers of the laser light sources assigned to the integrator rods 21R, 21G, and 21B may be made identical or different from one another. For example, if an amount of emitted G light is smaller than those of R light and B light, the number of the green laser light sources corresponding to one integrator rod 21G may be made larger than those of the red laser light sources and blue red light sources.

### Other Modification Examples of the Optical System

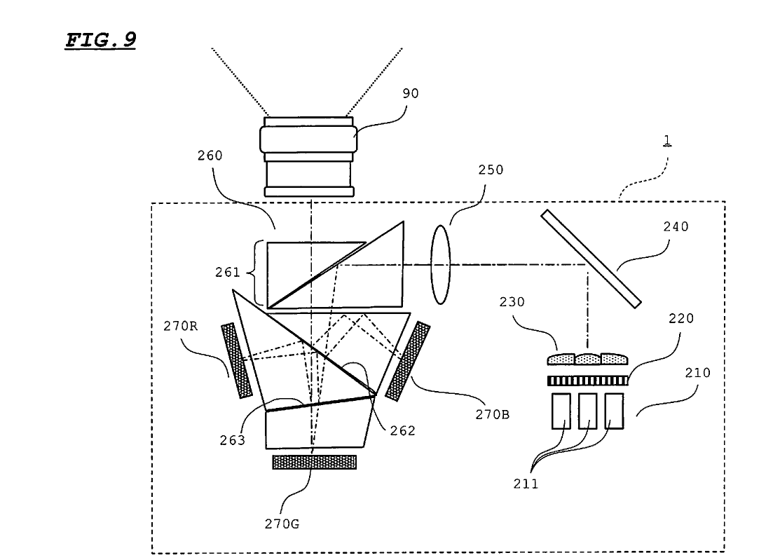

FIGS. 9 to 11 are diagrams for describing still other modification examples of the optical system of the illumination device 1.

FIG. 9 is a diagram showing a configuration of the optical system in the projector. The arrangement except for the projection lens 90 in FIG. 9 constitutes the optical system of the illumination device 1. In FIG. 9, an R light imager 270R, a G light imager 270G, and a B light imager 270B are equivalent to the modulating portions in the present invention; light source portions 211 constituting a light source device 210 are equivalent to the light source portions in the present invention; and a component part intervened between the light source device 210 and the R light imager 270R and between the G light imager 270G and the B light imager 270B, is equivalent to the light-guiding optical system of the present invention.

The illumination device 1 in this modification example includes the light source device 210, a fly-eye lens 220, a condenser lens array 230, a mirror 240, a condenser lens 250, and a 3-DMD color separation/combination prism 260.

The light source device 210 emits white illumination light in which R light, G light, and B light are combined. The illumination light emitted from the light source device 210 is entered into a TIR prism 261 of the 3-DMD color separation/combination prism 260 via the fly-eye lens 220, the condenser lens array 230, the mirror 240, and the condenser lens 250. The configuration of the 3-DMD color separation/combination prism 260 is identical to that of the 3-DMD color separation/combination prism 70 in the foregoing embodiment.

The illumination light entered into the 3-DMD color separation/combination prism 260 is separated by the dichroic films 262 and 263, and entered into the respective modulation areas of the reflective R light imager 270R, G light imager 270G, and B light imager 270B constituted by DMDs. These R light, G light, and B light modulated by the imagers 270R, 270G, and 270B are unified in light path by the 3-DMD color separation/combination prism 260, and the combined color light (image light) is entered from the TIR prism 261 to the projection lens 90.

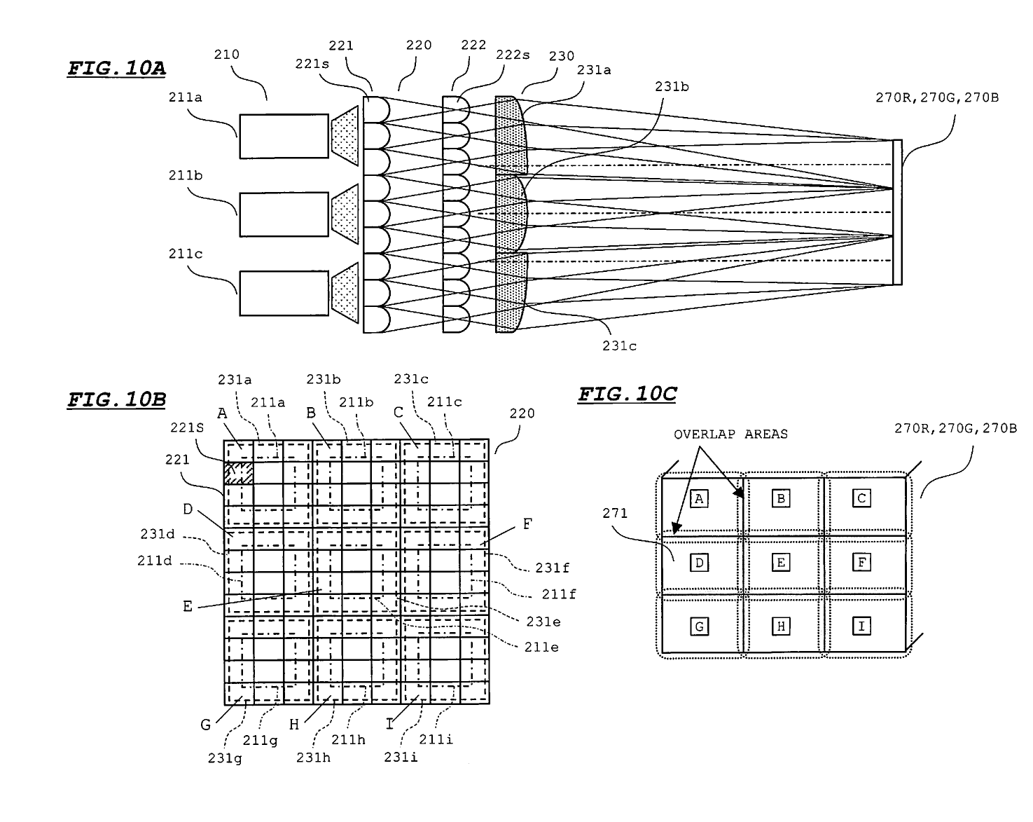

FIGS. 10A to 10C are diagrams for describing a configuration of the light source device 210, the fly-eye lens 220, and the condenser array 230. FIG. 10A is a schematic view of an optical system ranging from the light source device 210 to the imagers 270R, 270G, and 270B. In FIG. 10A, the mirror 240, the condenser lens 250, and the 3-DMD color separation/combination prism 260 are omitted for the sake of convenience.

FIG. 10B is a view of main parts of the optical system as seen from behind the light source device 210. In FIG. 10B, the light source portions 211 are depicted by one-dotted chain lines for the sake of convenience. In addition, reference codes A to I are given to radiation sections of the fly-eye lens 220 irradiated with laser light from the light source portions 211.

FIG. 10C is a schematic view of sections on the modulation areas 271 of the imagers 270R, 270G, and 270B irradiated with laser light emitted from the condenser lenses 231a to 231i of the condenser lens array 230. In FIG. 10C, reference codes A to I are given to sections of the imagers 270R, 270G, 270B irradiated with laser light from the condenser lenses 231a to 231i.

Referring to FIGS. 10A to 10C, the light source device 210 is formed by light source potions 211 (211a to 211i) arranged in three rows and three columns. Each of the light source portions 211 includes a red laser light source emitting R light, a green light laser source emitting G light, and a blue laser light source emitting B light. The R light, G light, and B light emitted from these laser light sources are combined within the light source portions 211 and then emitted to the outside.

The laser light emitted from the light source device 210 is entered into the fly-eye lens 220. The fly-eye lens 220 is formed by a first fly-eye lens 221 and a second fly-eye lens 222. The first and second fly-eye lenses 221 and 222 include cells 221S and 222S arranged in twelve rows and nine columns, respectively. Each of the cells 221S and 222S has an aspect ratio equal to an aspect ratio of the modulation areas 271 of the imagers 270R, 270G, and 270B (for example, 4:3).

As shown in FIGS. 10A and 10B, the laser light emitted from the light source portions 211a to 211i are radiated to the radiation sections A to I of the first fly-eye lens 221 corresponding to the light source portions 211a to 211i, respectively. Each of the radiation sections A to I is formed by total twelve cells 221S, arranged in four rows and three columns.

The laser light emitted from the individual cells 221S within the radiation sections A to I of the first fly-eye lens 221 passes through the corresponding cells 222S of the second fly-eye lens 222, and then is emitted to the condenser lens array 230.

The condenser lens array 230 is formed by nine condenser lenses 231a to 231i corresponding to the light source portions 211a to 211i. As shown in FIGS. 10A and 10B, the laser light emitted from the individual cells 222S of the radiation section A in the second fly-eye lens 222 is all entered into the corresponding condenser lens 231a. Similarly, the laser light emitted from the individual cells 222S of the other radiation sections B to I in the second fly-eye lens 222 is all entered into the corresponding condenser lenses 231b to 231i.

The modulation areas 271 of the imagers 270R, 270G, and 270B are each divided into nine sections A to I corresponding to the light source potions 211a to 211i (refer to FIG. 10C). The condenser lenses 231a to 231i are each designed in a predetermined curved shape such that centers of curvature thereof (shown by one-dotted chain line in FIG. 10A) align with centers of the divided sections A to I of the imagers 270R, 270G, and 270B, respectively.

The laser light entered from the individual cells 222S of the radiation section A in the second fly-eye lens 222 into the condenser lens 231a is superimposed on the corresponding divided sections A of the imagers 270R, 270G, and 270B by the lens functions of the condenser lens 231a and the condenser lens 250, as shown in FIG. 10A. Similarly, the laser light entered from the individual cells 222S of the other radiation sections B to I in the second fly-eye lens 222 into the condenser lenses 231b to 231i is also superimposed on the corresponding divided sections B to I of the imagers 270R, 270G, and 270B by the lend function of condenser lens 231b to 231i and condenser lens 250.

As the foregoing, in this modification example, the modulation areas 271 of the imagers 270R, 270G, and 270B are divided to the same number of sections as those of the light source portions 211, such that laser light from one light portion 211 is radiated to one divided section, as in the foregoing embodiment.

In this example, the fly-eye lens 220 (the second fly-eye lens 222) images laser light on the divided sections A to I set on the modulation areas 271 of the imagers 80R, 80G, and 80B. The fly-eye lens 220 (the second fly-eye lens 222) has a magnification ratio set in such a manner that a size of image formation of laser light on the divided sections A to I is slightly larger than that of the divided sections A to I. This creates overlap areas of laser light at boundaries between adjacent divided sections, as shown in FIG. 10C. This makes it possible to prevent boundary lines from appearing on a projection image.

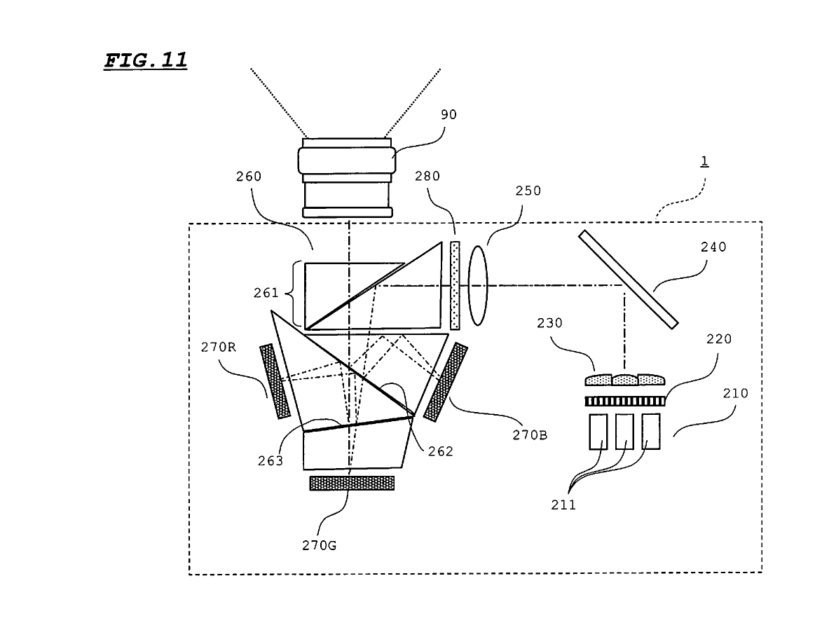

To prevent boundary lines on a projection image, the light-guiding optical system may have a diffuser, instead of adjusting a magnification ratio of the fly-eye lens 220. For example, a diffuser 280 may be interposed between the condenser lens 250 and the 3-DMD color separation/combination prism 260, as shown in FIG. 11. In this arrangement, laser light does not form a proper image on the imagers 270R, 270G, and 270B but overlaps slightly at boundaries between adjacent divided sections.

If an image is not properly formed by the diffusing function of the diffuser 25 as stated above, the image is blurred accordingly. Therefore, it is desired to use the diffuser 280 having the degree of diffusion with which the image blurriness does not become a problem from a practical standpoint.

The diffuser 280 may be disposed in the position shown in FIG. 11 or in any other position of the light-guiding optical system. For example, the diffuser 280 may be interposed between the first fly-eye lens 221 and the second fly-eye lens 222. In this case, the diffuser 280 can be made close to the incidence plane of the first fly-eye lens 221 as a object surface, which prevents an image from being blurred due to the diffuser 280. If the diffuser 280 is interposed between the condenser lens 250 and the 3-DMD color separation/combination prism 260 as shown in FIG. 11, the diffuser 280 is distant from both the object surface and the image planes (incidence planes of the imagers 270R, 270G, and 270B), a projection image is prone to be blurred by the diffusing function of the diffuser 280. Accordingly, in this case, the diffuser 280 needs to be made as smaller in degree of diffusion as possible, for prevention of blurriness of a projection image.

In addition, in this modification example, the fly-eye lens 220 is used in such a manner that the numbers of the vertical and horizontal cells 221S and 222S become the integral multiples of the numbers of the vertical and horizontal light source portions 211. The fly-eye lens 220 is configured in such a manner that the cells 221S and 222S as radiation sections are evenly assigned to the light source portions 211 and that no boundary between two radiation sections is formed in the middle of each of the cells 221S and 222S.

However, the fly-eye lens 220 may not be necessarily configured in such a manner that the numbers of the vertical and horizontal cells 221S and 222S become the integral multiples of the numbers of the vertical and horizontal light source portions 211. That is, a boundary between two radiation sections may be formed between in the middle of each of cells 221S and 222S. All that is needed is that laser light emitted from the light source portions 211 is radiated to the corresponding divided sections of the imagers 270R, 270G, and 270B while being unified in illuminance by the fly-eye lens 220 and the condenser lens array 230.

According to this modification example, it is possible to guide effectively light from the light source portions 211 to corresponding divided sections by the fly-eye lens 220 and the condenser lens array 230.

In the foregoing embodiment and this modification example, laser light sources are used as the light source portions. Alternatively, LED light sources may be used as the light source portions, for example.

Besides, the embodiments of the present invention can be appropriately modified in various manners within the scope of technical ideas shown in the claims.

What is claimed is:

1. An illumination device, comprising:
a modulating portion which modulates light;
a plurality of light source portions which is disposed in correspondence with a plurality of divided sections formed by dividing alight modulation area of the modulating portion;
a light-guiding optical system which guides light from the plurality of light source portions to the plurality of corresponding divided sections;
a power output adjustment portion which adjusts power outputs of the light source portions corresponding to the divided sections in accordance with image signals applied to the divided sections; and
a modulation control portion which controls the modulating portion in accordance with power outputs of the light source portions and the image signals.

2. The illumination device according to claim 1, wherein
the light-guiding optical system includes a plurality of integrator rods arranged in correspondence with the plurality of divided sections.

3. The illumination device according to claim 2, wherein
the light-guiding optical system includes a relay optical system which guides light emitted from the plurality of integrator rods to the corresponding divided sections, and
the modulating portion is disposed in a position different from an image plane formed by the relay optical system.

4. The illumination device according to claim 2, wherein
the light-guiding optical system includes:
a relay optical system which guides light emitted from the plurality of integrator rods to the corresponding divided sections; and
a diffuser interposed in the relay optical system.

5. The illumination device according to claim 1, wherein
the light-guiding optical system includes:
a fly-eye lens into which light emitted from the plurality of light source portions is entered, and
a plurality of condenser lenses into which light having passed through the fly-eye lens is entered, the condenser lenses being disposed in correspondence with the plurality of divided sections.

6. The illumination device according to claim 5, wherein
the fly-eye lens images the light on the divided section, and
a magnification ratio of the fly-eye lens is set in such a manner that sizes of light on the divided sections become larger than sizes of the divided sections.

7. The illumination device according to claim 5, wherein
the light-guiding optical system has a diffuser.

8. A projection display device, comprising:
an illumination device; and
a projection optical system which enlarges and projects image light from the illumination device, wherein
the illumination device has:
a modulating portion which modulates light;
a plurality of light source portions which is disposed in correspondence with a plurality of divided sections formed by dividing a light modulation area of the modulating portion;
a light-guiding optical system which guides light from the plurality of light source portions to the plurality of corresponding divided sections;
a power output adjustment portion which adjusts power outputs of the light source portions corresponding to the divided sections in accordance with image signals applied to the divided sections; and
a modulation control portion which controls the modulating portion in accordance with power outputs of the light source portions and the image signals.

9. The projection display device according to claim 8, wherein
the light-guiding optical system includes a plurality of integrator rods arranged in correspondence with the plurality of divided sections.

10. The projection display device according to claim 8, wherein
the light-guiding optical system includes:
a fly-eye lens into which light emitted from the plurality of light source portions is entered, and
a plurality of condenser lenses into which light having passed through the fly-eye lens is entered, the condenser lenses being disposed in correspondence with the plurality of divided sections.
